(19) United States
(12) Patent Application Publication
(10) Pub. No.: US 2002/0143090 A1
(43) Pub. Date: Oct. 3, 2002

(54) Color concentrates for polyesters

(76) Inventors: Thomas Joseph Pecorini, Kingsport, TN (US); Amie Elizabeth Real, Johnson City, TN (US); Emerson Eston Sharpe JR., Kingsport, TN (US)

Correspondence Address: Jacqueline M. Hutter, Needle & Rosenberg, PC, 127 Peachtree Street, Suite 1200, Atlanta, GA, 30303, US

(21) Appl. No.: 10/050,680

(22) Filed: Jan. 15, 2002

Related U.S. Application Data
(60) Provisional application No. 60/261,943, filed on Jan. 16, 2001.

(51) Int. Cl. C08K 3/18

(52) U.S. Cl. 524/430

(57) ABSTRACT

The invention relates to a concentrate for coloring polyesters comprising one or more copolymers and one or more colorants. The invention also relates to methods for coloring polyester materials using the concentrates disclosed herein and articles formed therefrom.

### CROSS-REFERENCE TO RELATED APPLICATIONS

This application claims priority to U.S. Provisional Application Serial No. 60/261,943, filed Jan. 16, 2001, the disclosure of which is incorporated herein in its entirety by this reference.

### FIELD OF THE INVENTION

The invention relates to color concentrates useful for processing polymeric materials. More particularly, it relates to the composition of the concentrates, methods of using the concentrates to process polymeric materials and to polymeric articles processed from such concentrates.

### BACKGROUND OF THE INVENTION

Polyesters, for example, polyethylene terephthalate (PET), poly(butylene terephthalate) (PBT) and poly(ethylene naphthalenedicarboxylate) (PEN), are useful polymers for packaging-type applications. Such materials can be processed into containers, sheets and other packaging articles by processes such as, for example, injection molding, film extrusion, sheet extrusion or blow molding. Articles made from such polyesters are generally known to exhibit properties such as, for example, toughness, chemical resistance and stiffness. The polyesters can be used in applications such as, for example, bottles, jars, blister packaging and other similar applications.

Many uses for polyesters take advantage of the excellent clarity of these materials. In particular, PET is commonly used to manufacture carbonated soft drink bottles. Nonetheless, some uses, although incorporating the other beneficial properties of polyester, require opacity or translucency, as opposed to transparency. For such applications, color concentrates can be used to incorporate a colorant to opacify or color the article.

However, polyesters, in particular, PET, have been found to be difficult materials to color. For example, even a minimal amount of retained water in the coloring system can lead to hydrolytic degradation of the PET during processing. For this reason, one method of coloring PET involves preparing a concentrate of colored pigment in a crystallized PET base. The crystallized PET-based concentrate pellet can be dried separately or blended with virgin crystallized PET and then dried at, for example, about 150° C. to reduce hydrolytic degradation in the finished polyester material. If any uncrystallized PET-based concentrate pellets are present, these must be dried at a lower, less effective drying temperature due to its softening point of 80° C. (glass transition temperature).

While this method is, in theory, a satisfactory method of drying of color concentrates, in practice, the technique can be inconvenient and costly. As a result, shortcuts may be taken in conducting the process, thereby resulting in incomplete drying and degradation in the finished polyester article. As an additional difficulty with this process, because uncrystallized concentrate pellets can stick to each other at PET drying temperatures, it is often necessary to require crystallized PET-based concentrate pellets to allow the pellets to flow freely in a feed throat. This extra step can reduce the economies of the process. Furthermore, the polyester base material of the pellet may not be a good dispersion aid for many pigments thus leading to a distribution of pigment in the final article that may not be optimal. This poor distribution of pigment has been found to produce swirling lines in the bottle (a/k/a “swirls”).

Another approach to coloring polyesters can be to use a low melt viscosity waxy material (such as a stearyl phthalate or a polyolefin wax) as the concentrate base. Such a system is described in U.S. Pat. No. 4,988,477, the disclosure of which is incorporated herein in its entirety by this reference. Such a low melt viscosity material might satisfactorily disperse a pigment, but could melt prematurely at the feed throat and create difficulties during processing such as obstructing flow or causing excessive screw slippage.

Another approach is described in U.S. Pat. No. 5,686,515, the disclosure of which is incorporated herein in its entirety by this reference. This disclosure indicates that the coloring of polyester can be improved by using a concentrate formulation comprising a colorant combined with both a wax dispersant and an ethylene copolymer. A similar concept is described in U.S. Pat. No. 5,670,561, the disclosure of which is incorporated herein in its entirety by this reference, where the process comprises a plastic coloring concentrate comprising a low melt viscosity resin (such as a wax), an ethylene copolymer (such as ethylene methyl acrylate or ethylene acrylic ester) and a colorant. According to these two patents, coloring can be improved by the use of the wax to improve dispersion of the pigment in the concentrate. In addition, U.S. No. Pat. 5,686,515 indicates that the concentrate provides a pearlescent look to the polyester. Although U.S. Pat. Nos. 5,670,561 and 5,686,515 offer certain improvements, they require the complexity of processing two materials—the wax and the ethylene copolymer—to create a carrier for the colorant.

Those skilled in the art of processing polyesters would prefer a color concentrate that is of a solid pellet form so as to allow more efficient materials handling and usage, does not need to be dried or has low moisture uptake, allows good dispersion of a colorant in PET, requires a low addition rate to the polyester to achieve the desired uniform opacity and color, and is competitively priced due to a simplified manufacturing process and reasonable raw material costs.

### SUMMARY OF THE INVENTION

The invention relates to a concentrate for coloring polyesters comprising one or more copolymers and one or more colorants. The invention also relates to methods for coloring polyester materials using the concentrates disclosed herein and articles formed therefrom.

Additional advantages of the invention will be set forth in part in the description that follows, and in part will be apparent from the description, or can be learned by practice of the invention. The advantages of the invention will be realized and attained by means of the elements and combination particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

FIG. 1 depicts an apparatus for letting down a concentrate into a base polyester.

### DETAILED DESCRIPTION OF THE INVENTION

The present invention can be understood more readily by reference to the following detailed description of the invention and the Examples included therein and to the Figure and its previous and following description. It is also to be understood that the terminology used herein is for the purpose of describing particular aspects only and is not intended to be limiting.

It must be noted that, as used in the specification and the appended claims, the singular forms “a,” “an” and “the” include plural referents unless the context clearly dictates otherwise. Thus, for example, reference to “an aromatic compound” includes mixtures of aromatic compounds.

Often, ranges are expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

In this specification and in the claims that follow, reference will be made to a number of terms that shall be defined to have the following meanings:

The term “copolymer” as used herein refers to polymers comprising two or more monomeric units in the same molecule. The term is intended to include materials commonly referred to as copolymers, terpolymers, block copolymers, random copolymers, alternating copolymers, graft copolymers and other similar terms.

The term “acrylate” as used herein refers to an ester of acrylic acid or an ester of a derivative of acrylic acid such as methacrylic acid.

The term “methacrylate” as used herein refers to an ester of methacrylic acid or an ester of a derivative of methacrylic acid.

The term “base polyester” means a polyester to which a colorant material according to the present invention has not been added. The base polyester can be supplied having one or more additives that would be considered by one of ordinary skill in the art to be “colorants” such as, for example, TiO₂. However, such polyesters are still considered to be “base polyesters.”

A “polyester composition” is a composition comprised of a base polyester and a colorant according to the present invention.

The invention relates generally to methods for coloring a polyester material by letting down the color concentrate (hereinafter “concentrate”) into a base polyester such that the concentrate is generally dispersed throughout the polyester material, and also to methods for making an article, such as a molded or an extruded article, from the colored polyester material. The invention herein provides previously unknown improvements to the finished polyester compositions and articles made therefrom, as well as improvements in the processing steps, such as, for example, reducing elongation and stringing at gates used during the processes, reduced embrittlement of articles made during the processes, reduced slippage at an extrusion screw during the processes leading to more consistent screw recovery time, and increased stability of barrel temperature due to reduced shearing of PET during the processes. In accordance with the present invention, PET colored with the concentrates of the present invention has a higher inherent viscosity (I.V.) than PET colored by conventional methods, as well as certain improved physical attributes, such as color content (especially reduced swirl content), increased resistance to destratification, reduced moisture content, and a stronger and more aesthetically pleasing gate area Articles formed from the polyester compositions of the present invention can also exhibit these properties.

In a major aspect, the concentrate comprises two primary components: one or more colorants and one or more copolymers.

The term “copolymer” as used herein refers to polymers comprising two or more monomeric units in the same molecule. The term is intended to include molecules commonly referred to as copolymers, terpolymers, block copolymers, random copolymers, alternating copolymers, graft copolymers and other similar terms.

Colorants useful for the concentrates of the invention include pigments, dyes, and other colorants. It is envisioned that virtually any pigment or dye currently used, or developed in the future, suitable for coloring polyesters can be employed The pigment can be organic or inorganic in nature. Examples of inorganic pigments include, but are not limited to, titanium oxide, iron oxide, aluminum oxide, magnesium oxide, zinc sulfide, cobalt, cadmium, ultramarine and carbon black. Examples of organic pigments include, but are not limited to, sulfium baryte, azo pigments, condensed azo pigments, phthalocyanine, quinacriadone, isoindolinone, anthraquinone and pearlene type pigments. Examples of dyes include, but are not limited to, quinopthalone, perinone, anthraquinone, thioxanthene, thioindigo, xanthene and coumarin. Other examples of colorants include, but are not limited to, titanium dioxide, red iron oxide, lead chromate, ultramarine blue, molybdate orange, phthalocyanine blue, quinacridone, phthalocyanine green, red lake C, black iron oxide and other similar colorants. The colorants can be used individually or in combination with each other. In particular, mixtures can be used to provide a desired color, as would be known to one of ordinary skill in the art. The specific colorant or mixture of colorants is not critical to the invention herein. Other useful colorants would be apparent to those of ordinary skill in the art.

Copolymers useful for the concentrates of the invention include copolymers of olefins, acrylates and methacrylates. Particularly useful copolymers can include olefin/acrylate copolymers, olefin/methacrylate copolymers, other comparable copolymers and mixtures thereof The copolymers suitable for use herein typically have melt indices of from about 0.2 to about 50 gms/10 min, as measured according to the procedures specified in ASTM D-1238. The copolymers can be prepared by procedures well known to one of ordinary skill in the polymer art.

The olefin component of the copolymer contains from about 2 to about 18 carbon atoms. In further aspects, the copolymer can contain from about 3, 4, 6, 8, 10, 12, 14, 16 and 18 carbon atoms where any of these values can be used as the upper and lower limits, as appropriate. In further aspects, the olefin component can comprise one or more of: ethylene, propylene or butylene. Still further, the olefin component of the copolymer can comprise ethylene. In further aspects, the olefin component of the copolymer can comprise from about 40 to about 99 wt. %, or from about 70 to about 97 wt. %, or from about 75 to about 95 wt. % of the copolymer. Still further, the olefin component can comprise from about 40, 45, 50, 55, 60, 65, 70, 75, 80, 85 , 95 or 99 wt % of the copolymer, where any of the recited values can be used as the upper endpoint or lower endpoint, as appropriate.

The acrylate or methacrylate component of the copolymer can comprise alkyl acrylates, alkyl methacrylates, or combinations thereof, with a composition of:

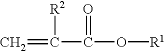

wherein R¹ is alkyl group of up to about 8 carbon atoms, preferably an alkyl group of 1 to 4 carbon atoms, and R² is hydrogen, methyl or ethyl. The amount of acrylate or methacrylate component in the copolymer can comprise from about 1 to about 60 wt %, or from about 3 to about 30 wt. %, or from about 5 to about 25 wt. % of the copolymer. Still further, the amount of acrylate or methacrylate component in the copolymer component can comprise from about 1, 3, 5, 7, 10, 15, 20, 25, 30, 35, 40, 45, 50, 55 or 60 wt. %, where any lower value can be used as the lower endpoint and any upper value can be used as the upper endpoint, as appropriate. Particular alkyl acrylates that can be utilized can comprise methyl, ethyl, propyl, and butyl esters of acrylic or methacrylic acid. As used herein, the amount of acrylate or methacrylate component in the copolymer can be determined by a total wt. % of the acrylate, including the alkyl group.

Examples of specific copolymers that can be utilized in the invention herein include, but are not limited to, one or more of: ethylene methyl acrylate copolymers (EMA), ethylene methyl methacrylate copolymers (EMMA), ethylene ethyl acrylate copolymers (EEA), ethylene ethyl methacrylate copolymers (EEMA), ethylene butyl acrylate copolymers (EBA), ethylene butyl methacrylate copolymers (EBMA) and other similar copolymers. Still further, the copolymer utilized does not comprise EMA.

The concentrates of the present invention can also include other materials such as one or more additives known to those of ordinary skill in the art. Such additives include for example, but are not limited to, heat stabilizers, UV stabilizers, antioxidants, UV absorbers, biocides, plasticizers, or fillers such as clay, mica, talc, ceramic spheres, glass spheres, glass flakes and the like. Additives such as these are typically used in relatively small quantities in the final polyester material to which the concentrate is added. In the components recited herein, the presence of the one or more additives is not considered in the calculation of weight percents described herein for materials used in the concentrate or in the polyester composition to which the concentrate is added to the base polyester.

In further aspects, the concentrate does not comprise a low melt viscosity resin. By “low melt viscosity resin” it is meant those materials described in detail in U.S. Pat. No. 5,670,561, as well as any materials that would be recognized by one of ordinary skill in the art to be substitutable therefore.

The concentrate can be prepared by combining its primary components, that is, the one or more colorants and the one or more copolymers, as well as any additives, using methods known generally to those skilled in the art, such as by use of an extruder or Banbury mixer.

In accordance with the present invention, the use of only two primary components can simplify the manufacture of the concentrate. For example, in prior art concentrates that use a waxy material as a dispersant in addition to an olefin copolymer and a colorant (such as those disclosed in U.S. Pat. Nos. 5,686,477 and 5,670,561), the wax is premixed with the colorant prior to melt blending with copolymer. The complexity introduced by this extra step creates a more difficult process than simply adding the colorant to the copolymer. It has unexpectedly been found that the waxy material is not needed as a dispersant which, in turn, leads to improvements in the manufacturing economies or of the present invention.

For effectiveness in dispersing the colorant throughout the concentrate, dispersing the concentrate throughout a base plastic and in coloring the base plastic, the concentrates of the present invention can comprise from about 20 wt. % to about 80 wt. % of the copolymer and about 80 wt. % to about 20 wt. % colorant. Still further, the concentrates can comprise from about 20 wt. % to about 60 wt. % of the copolymer and about 80 wt. % to about 40 wt. % colorant Still further, the ratio of copolymer:colorant can be from about 80:20, 70:30, 60:40, 50:50, 40:60, 30:70 or 20:80, where all values are in wt. %. Yet still further, the amount of copolymer in the color concentrate is greater than 25 wt. % or, still further, greater than about 30 wt. %.

The melt flow rates of the copolymers can range from about 0.2 to about 50 gms/10 min. Still further, the melt flow rates of the copolymers can be from about 0.2, 0.5, 1, 5, 10, 15, 20, 25, 30, 35, 40, 45 or 50 g/10 min. where any lower value can be used as a lower endpoint and any upper value can be used as an endpoint, as appropriate.

The concentrate can be let down into virtually any polyester material to disperse the concentrate throughout the polyester and to color the polyester. Polyesters suitable for the invention include, but are not limited to, poly(ethylene terephthalate) (PET); poly(ethylene terephthalate) modified with cyclohexane dimethanol (such as PETG available from Eastman Chemical Company, Kingsport, Tenn); poly(1 ,4-cyclohexylenedimethylene terephthalate) (PCT); poly(1,4-cyclohexylenedimethylene terephthalate) modified with ethylene glycol (such as PCTG available from Eastman Chemical Company); poly(1 ,4-cyclohexylenedimethylene terephthalate) modified with isophthalic acid (PCTA); poly(ethylene naphthalenedicarboxylate) (PEN); poly(butylene terephthalate) (PBT); poly(trimethylene terephthalate) (PTT); poly(esters of carbonic acid) (PC); and other similar polyesters. The particular polyester is not critical to the invention. Other suitable polyesters will be apparent to one of ordinary skill in the art.

In a further aspect, the polyester can be crystallized, partially crystallized or uncrystallized.

The concentrates can be added to the polyester at from about 0.1 to about 10 wt. % or from about 1.0 to about 5.0 wt. %, or from about 1.5 to about 3.0 wt. %. Still further, the concentrates can be added to the polyester at from about 0.5, 1, 2, 3, 4, 5 or 10 wt. % where any lower value can be used as a lower endpoint and any upper value can be used as the upper endpoint, as appropriate. The concentrates can be combined with the polyester either by premixing with the polyester as a dry pellet blend or through the use of a separate additive feeder during processing, such as, for example, by using feeders produced by Movacolor, Plastrac or Plastore.

Polyesters colored with these concentrates can be processed with any known polyester processing technique, including, but not limited to, injection molding, injection blow molding, injection stretch blow molding, extrusion blow molding, sheet extrusion, profile extrusion, calendering, or other similar processes.

As noted, reduction in moisture in the final colored polyester compositions and articles formed therefrom is a desirable result seen with the present invention. Accordingly, in a significant aspect, the amount of moisture in a final polyester composition colored with the concentrates of the present invention is less than about 0.1 wt. %. Still further, the amount of moisture in a final polyester composition colored with the concentrates of the present invention is less than about 0.075 wt. %. Such lowered moisture amounts are also seen in the articles formed from such polyester compositions.

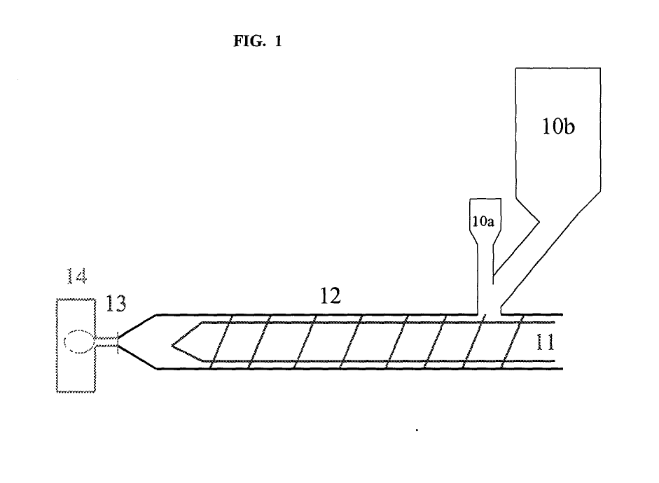

An apparatus suitable for letting down the concentrate into a base polyester and for extruding the polyester into a mold is depicted in a general manner in FIG. 1. The apparatus depicted in the Figure comprises one or more hoppers 10a and 10b, an extrusion screw 11, a barrel 12, agate 13, and a mold 14. The hoppers are connected to the barrel 12 which is connected to the mold 14. A gate 13 controls whether the passage from the barrel into the mold is open or closed. Concentrate pellets and base polyester pellets are fed, usually through separate hoppers 10a and 10b, such the pellets fall into openings within the threads of the extrusion screw 11. The extrusion screw turns such that the screw moves axially right and the pellets move axially left. The barrel 12 is heated such that the concentrate and polyester pellets form a hot melt. As the extrusion screw 11 turns, the unmelted pellets frictionally rub against the barrel 12 and become heated further. The extrusion screw 11 turns until a sufficient amount of pellets have been moved to the left to form a sufficiently large volume of hot melt adjacent to the gate 13. The extrusion screw 11 then stops rotating, the gate 13 opens, and the extrusion screw 11 translates axially to the left to drive the hot melt into the mold 14 under pressure.

Typically, the shape of the mold 14 will be such that the mold 14 will create a desired molded article. Typical molded articles include, but are not limited to, a plastic preform for a plastic container or other molded articles. Techniques for molding such shapes are well known to those skilled in the art. Hence, further detailed description of mold 14 and the molding process is not necessary herein.

Articles made according to the invention can be single-layered or multi-layered A multi-layered article can have at least one layer that comprises the colored polyester composition prepared according to the invention.

In the particular case wherein the article is a molded preform, the preform can typically be made into a plastic container by blow molding. Such processes are well known to those of ordinary skill in the art.

The coloring of the base polyester can typically be accomplished in the letting down of the polyester and in the molding or other processing to make an article. In the particular case of the article being a preform, the quality of the color of the eventual molded plastic container will be typically be determined by the quality of the coloring of the preform.

Compositions formed from addition of the color concentrates of the present invention to a base polyester exhibit improvements in I.V. in comparison to compositions prepared from a base polyester colored with concentrates not containing copolymers as disclosed herein. One of ordinary skill in the art would recognize that colorants generally reduce the I.V. of polyester materials because of hydrolytic degradation. Thus, one of ordinary skill in the art would expect a measurable decrease in I.V. when adding a color concentrate to a polyester. Unexpectedly, however, the concentrates of the present invention reduce the I.V. of a base polyester to a lesser degree than prior art color concentrates. In particular, when added in the amounts disclosed previously, the color concentrates of the present invention cause a decrease in the I.V. of the base polyester by equal to or less than 0.04 dL/g. For example, if the uncolored base polyester exhibits an I.V. of 0.7 dL/g, the base polyester to which a color concentrate of the invention has been added will exhibit an I.V. in the range of about 0.66 to about 0.7 dL/g. This is in comparison to prior art color concentrates that will cause greater decrease in I.V. when added to the same type of base polyester.

Inherent viscosity (I.V.) as used herein refers to viscosity determinations made at 25° C. using 0.50 gram of polymer per 100 mL of a solvent composed of 60 wt. % phenol and 40 wt. % tetrachloroethane. The basic method of determining the I.V. of the polyesters herein is set forth in ASTM method D2857-95, the disclosure of which is incorporated in its entirety by this reference.

A further aspect of the invention comprises utilizing the copolymer itself as a “colorant” to provide a pearlescent effect to the polyester. In this aspect, the copolymer comprising one or more of olefin/acrylate or olefin/methacrylate copolymer is used substantially without any added pigment or dye to provide an opaque polyester with a desirable pearlescent look. To obtain such polyester, the polyester can comprise from about 2 wt. % to about 40 wt % of the copolymer, or from about 5 wt. % to about 35 wt. % of the copolymer, or from about 10 wt. % to about 25 wt. % of the copolymer. Still further, the copolymer can comprise from about 2, 5, 7, 10, 15, 20, 25, 30, 35 or 40 wt. % of the polyester (all in wt. %), where any lower value or upper value can be used as an endpoint, as appropriate.

Experimental

The following examples are put forth so as to provide those of ordinary skill in the art with a complete disclosure and description of how the articles, compositions and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

Concentrates were prepared on a 30 mm twin screw extruder from Werner and Pfleiderer at a temperature of 230° C. and a rate of 16 pounds/hour (265° C. and 20 pounds/hour for the concentrate containing PET). Preforms were molded on a Boy22 injection molding machine at a temperature of 285° C. Bottles were blown on a SBO ⅔ from SIDEL. All percentages below are by weight unless otherwise indicated. (Note that all concentrates were made to comprise 25% titanium dioxide by volume.) The titanium dioxide (TiO₂) used in the following examples was DuPont Ti-Pure R-100 W-18 (E.I. DuPont DeNemours, Wilmington, Del.). The PET used to make the bottles was an Eastapak 9921W from Eastman Chemical Company. The PET was dried for 8 hours at 150° C. prior to injection molding. The dried PET was cooled in the dryer to 60° C. prior to bag blending with any additional color concentrate. The concentrates were not dried. The concentrates were added to the polyester material to provide a level of TiO₂ of 1.25% in the final bottle.

### COMPARATIVE EXAMPLE 1

PET 9921 W with no added colorant was molded into preforms and blown into bottles. The I.V. of the bottles was 0.68. The bottles were clear.

### COMPARATIVE EXAMPLE 2

A concentrate was made of 50% PET 9921W and 50% TiO₂. PET 9921W was pellet blended with 2.5% of this concentrate, molded into preforms, and blown into bottles. The I.V. of the bottles was 0.62. Therefore, the IV of the base polyester dropped by 0.06 dL/g. The bottles were opaque, but swirls were visible.

### EXAMPLE 1

A concentrate was made of 40% EMAC® SP2260 (Eastman Chemical Co., Kingsport, Tenn.) and 60% TiO₂. EMAC® SP2260 is a copolymer of ethylene and 24% methyl acrylate, with a melt index of 2.1 g/10 min. PET 9921W was pellet blended with 2.08% of this concentrate, molded into preforms, and blown into bottles. The I.V. of the bottles was 0.67. Therefore, the IV of the base polyester dropped by 0.01 dL/g with the color concentrates of the invention. The bottles were opaque with no swirls visible.

### EXAMPLE 2

A concentrate was made of 40% EMAC® PLUS SP1305 (Eastman Chemical Co., Kingsport, Tenn.) and 60% TiO₂. EMAC® PLUS SP1305 is a copolymer of ethylene and 20% methyl acrylate, with a melt index of 2.0 g/10 min. PET 9921W was pellet blended with 2.08% of this concentrate, molded into preforms, and blown into bottles. The I.V. of the bottles was 0.67. Therefore, the IV of the base polyester dropped by 0.01 dL/g with the color concentrates of the invention. The bottles were opaque with no swirls visible.

### EXAMPLE 3

A concentrate was made of 40% EBAC® SP1802 (Eastman Chemical Co.) and 60% TiO₂. EBAC® SP1802 is a copolymer of ethylene and 22.5% butyl acrylate, with a melt index of 0.5 g/10 min. PET9921W was pellet blended with 2.08% of this concentrate, molded into preforms, and blown into bottles. The I.V. of the bottles was 0.64. Therefore, the IV of the base polyester dropped by 0.04 dL/g with the color concentrates of the invention. The bottles were opaque with no swirls visible.

### EXAMPLE 4

PET 9921W was pellet blended with 5% EMAC® SP2260, molded into preforms, and blown into bottles. The I.V. of the bottles was 0.66. Therefore, the IV of the base polyester dropped by 0.02 dL/g with the color concentrates of the invention. The bottles were translucent with a pearlescent appearance.

### EXAMPLE 5 AND COMPARATIVE EXAMPLES 3-6

The following examples show moisture contents of various commercial color additives compared with examples of the invention. Moisture was measured with a Mitsubishi moisture meter. It is important to reduce the amount of water in the color additive to reduce the potential for hydrolytic degradation of the PET during processing. Hydrolytic degradation leads to a reduction in I.V. of the final processed bottle. The data show polyester materials made according to the invention contain less moisture than other polyesters colored with other colorant methods.

TABLE 1
COMPARISON OF MOISTURE VALUES

| | | Pellet |
|---|---|---|
| Example | Colorant | Moisture |
| Comparative Example 3 | Holland white powder | 0.105% |
| Comparative Example 4 | Colormatrix liquid white | 0.195% |
| Comparative Example 5 | Hanna white PET base pellets | 0.295% |
| Comparative Example 6 | Holland Holcoprill white wax prill | 0.559% |
| Example 5 | Concentrate used in Example 1 | 0.053% |

All publications referenced herein are incorporated herein in their entireties by this reference.

The invention has been described in detail with particular reference to the various aspects thereof, but it will be understood that variations and modifications can be effected without departing from the scope of the invention.

What is claimed is:

1. A concentrate for coloring abase polyester comprising:
a) one or more colorants; and
b) from about 20 wt. % to about 80 wt. % of one or more copolymers comprising one or more of olefin/macrylate copolymer or olefin/methacrylate copolymer;
wherein the wt. % is measured by total weight of the concentrate.

2. The concentrate of claim 1, wherein the copolymer comprises one or more of:
EMA, EMMA, EEA, EBA or EBMA.

3. The concentrate of claim 1, wherein the copolymer is present in the concentrate at from about 20 wt. % to about 60 wt. %, as measured by total weight of the concentrate.

4. A polyester composition comprising the concentrate of claim 1 and a base polyester, wherein the concentrate is present at from about 0.1 wt. % to about 10 wt. %, as measured by total weight of the composition.

5. The polyester composition of claim 4, wherein the concentrate is present in the composition at from about 1 wt. % to about 5 wt. %, as measured by total weight of the composition.

6. The polyester composition of claim 4, wherein the composition has a moisture content of less than about 0.1 wt. % as measured by total weight of the composition.

7. The polyester composition of claim 4, wherein the I.V. of the composition is equal to or less than about 0.04 g/dL below the I.V. of the base polyester.

8. The polyester composition of claim 4, wherein the olefin component of the copolymer comprises from about 40 wt. % to about 99 wt. % of the copolymer.

9. A molded article prepared from the polyester composition of claim 4.

10. A method for preparing a colored polyester composition comprising:
a. adding a color concentrate to a base polyester material, wherein the concentrate comprises:
i. one or more colorants; and
ii. from about 20 wt. % to about 80 wt. % of a copolymer comprising one or more of: olefin/acrylate copolymer or olefin/methacrylate copolymer,
wherein the wt. % of the concentrate is measured by total weight of the copolymer and colorant.

11. The method of claim 10, wherein the I.V. of the composition is equal to or less than about 0.04 g/dL below the I.V. of the base polyester.

12. The method of claim 10, wherein the copolymer comprises one or more of EMA, EMMA, EEA, EBA or EBMA.

13. The method of claim 10, wherein the copolymer is present in the concentrate at from about 20 wt. % to about 60 wt. %, as measured by total weight of the concentrate.

14. The method of claim 10, wherein the concentrate is present from about 0.1 wt. % to about 10 wt. %, as measured by total weight of the composition.

15. The method of claim 10, wherein the concentrate is present at from about 1 wt. % to about 5 wt. %, as measured by total weight of the composition.

16. The method of claim 10, wherein the composition has a moisture content of less than about 0.1 wt. %, as measured by total weight of the composition.

17. The method of claim 10, wherein the olefin component of the copolymer comprises from about 40 wt. % to about 99 wt. % of the copolymer, as measured by total weight of the copolymer.

18. The method of claim 10, further comprising the step of forming the colored polyester composition into a molded article.

19. A method of coloring a polyester composition consisting essentially of adding to a base polyester a copolymer comprising one or more of EMA, EMMA, EEA, EBA or EBMA, thereby providing a colored polyester composition.

20. The method of claim 19, wherein the copolymer is added at from about 2 wt. %, to about 40 wt. %, as measured by total weight of the composition.
